(19) United States
(12) Patent Application Publication
(10) Pub. No.: US 2017/0016323 A1
(43) Pub. Date: Jan. 19, 2017

(54) Friction Welded Insert and Processes for Inserting the Insert into a Substrate

(71) Applicant: Caterpillar Inc., Peoria, IL (US)

(72) Inventors: Matthew Behmlander, Metamora, IL (US); Timothy Thorson, Morton, IL (US); Fernando Martinez Diez, Dunlap, IL (US)

(73) Assignee: Caterpillar Inc., Peoria, IL (US)

(21) Appl. No.: 14/799,647

(22) Filed: Jul. 15, 2015

(51) Int. Cl. E21C 35/19; B23K 20/12; C04B 37/00

(52) U.S. Cl. CPC E21C 35/19; C04B 37/00; B23K 20/12; E21C 2035/1806

(57) ABSTRACT

A method for attaching an insert to a substrate includes: rubbing the insert against the substrate; forming a heat-affected zone in the substrate; forming plasticized substrate material from friction resulting from the rubbing; moving the insert to a first depth in the heat-affected zone in the substrate; moving the insert to a second depth in the heat-affected zone in the substrate where the first depth is deeper than the second depth; flowing the plasticized material against the insert; and releasing the insert.

### TECHNICAL FIELD

The present disclosure is related to a wear-resistant insert used in such machinery like road paving and mining equipment, and more particularly to a method of joining the wear-resistant insert with a base substrate component using a method of friction welding.

### BACKGROUND

Wear-resistant inserts, herein also referred to as inserts, are commonly brazed or press fit into place to improve wear resistance of road paving or mining equipment. These types of ground engaging elements are high wear parts and so assembling them into machinery in a cheap, yet efficient and sturdy manner, is desired. The inserts are intended to withstand substantial and repetitive forces when used with any ground-engaging tool. For example, the rotor drum of an asphalt reclaimer may include many smaller cutter bits that often are brazed into their respective piece holders. The asphalt reclaimers pulverize the asphalt layer and mix it with the underlying base. The reclaimers can add asphalt emulsions or other binding agents during pulverization or during a separate mix pass. Softer metallic materials do not exhibit the required theoretical strength properties for the purpose of such heavy-wear use with a rotary workpiece or rotor drum. To address that limitation, the design of the parts can be made to avoid or limit the need for such assembly components, but that approach generally involves more machining operations and more parts to produce the desired assembly.

One problem which may arise when working in the field of ground-engaging road paving or mining equipment is that wear-resistant inserts are often brazed or press-fit into a base component. However, over time, the braze tends to wear out or the insert starts to wear away the base material around it and the insert falls out. Brazing is also time-consuming. This may cause inefficiencies and failures of expensive equipment and slows down processes that rely on multiple small moving parts to be working seamlessly together.

Alternative approaches have been applied to product assembly, such as the friction welding methods like that disclosed in U.S. Pat. No. 8,708,628, where a component for use with a rotary tool is inserted through a surface of a workpiece made of a material showing friction-induced plasticity and rotated in a first direction while an axial force is applied onto the component. Better methods of friction welding may be desired to create stronger “welds.”

A problem which may also arise in friction-welding two separate parts together is that the resultant piece often does not produce the desired wear resistance that is needed for repetitive use in heavy machinery. Parameters like cost, efficiency and a first life-cycle of a machine come into play. Achieving a longer-lasting wear-resistant insert and method to better join two components is desired to provide enhanced mechanical traction retention of the wear-resistant insert.

And yet another problem that may arise is that when welding a wear-resistant insert and a wear base component together, a stress concentration often referred to as a stress riser, occurs on an object where the stress is concentrated. This can lead to a mechanical defect with either or both the wear-resistant insert and the base-wear component which in turn can cause a material to fail. For example, a propagating crack can cause a material to fail when a concentrated stress exceeds the material's strength. Further, fatigue cracks often start at stress risers, so removing such defects increases the fatigue strength.

Many of these and other shortcomings of the prior art are addressed by the various embodiments desirable in the present disclosure.

### SUMMARY

In some embodiments, an insert may be provided. The insert may include: a body, having an engaging portion and a free portion located opposite the engaging portion; a side portion of the body defining a retention cavity, the retention cavity being located closer to the engaging portion than the free portion; a junction between the retention cavity on a side of the portion defining a rounded surface; and a protrusion extending from a surface on the engaging portion.

In some embodiments, a ground engaging element for a machine is provided. The ground engaging element may include: a substrate; an insert having a body, which has an engaging portion and a free portion located opposite the engaging portion; a side portion of the body defining a retention cavity, the retention cavity being located closer to the engaging portion than the free portion; a junction between the retention cavity on a side of the portion defining a rounded surface; and a protrusion extending from a surface on the engaging portion; and wherein the insert is embedded into the substrate and the substrate material is located in the retention cavity.

In some embodiments, a method for attaching an insert to a substrate is provided. The method may include: rubbing the insert against the substrate; forming a heat-affected zone in the substrate; forming plasticized substrate material from friction resulting from the rubbing; moving the insert to a first depth in the heat-affected zone in the substrate; moving the insert to a second depth in the heat-affected zone in the substrate, wherein the first depth is deeper than the second depth; flowing the plasticized material against the insert; and releasing the insert.

### BRIEF DESCRIPTION OF THE DRAWINGS

FIG. 1 is a partially cut-away diagram of a ground-engaging machine that includes at least one friction welded wear-resistant insert in accordance with aspects of the present disclosure.

FIG. 2 is a side view of an exemplary design of a wear-resistant insert with aspects of the present disclosure.

FIG. 3 is a side view of an exemplary design of a wear-resistant insert with aspects of the present disclosure.

FIG. 4 is a side view of an exemplary design of a wear-resistant insert with aspects of the present disclosure.

FIG. 5 is a side view of an exemplary design of a wear-resistant insert with aspects of the present disclosure.

FIGS. 6-8 are side cross-sectional views of the presently disclosed wear-resistant insert entering a base wear component.

FIG. 9 is a top view of an embodiment showing orbital friction welding that can be utilized according to the present disclosure.

FIG. 10 is a top view of an embodiment showing linear friction welding that can be utilized according to the present disclosure.

FIG. 11 is a flow chart illustrating a method of friction welding the insert and base substrate together.

### DETAILED DESCRIPTION

In one aspect of the present disclosure, friction may be used to generate heat in order to make a base substrate material that is referred to herein as a “plasticized” substrate material so that a wear-resistant insert may be inserted inside the base substrate material. Plasticized, however, and can mean a plasticized, a semi-plasticized material, molten, molten-like, or other material that is softened or will flow as a result of being heated. Once the insert is placed in the base material, the base material and insert will cool and thus be permanently joined. In some embodiments where no melting occurs, friction welding is not actually a welding process in the traditional sense, but a forging technique. However, due to the similarities between these techniques and traditional welding, the term “friction weld” has become common. The insert could be rotated, rubbed, and/or simultaneously pressed into the base by a welding tool that is similar to a friction stir welding machine, mill, or lathe. Frictional heat is generated at the contact point or area between the surfaces caused by the rubbing of the insert on the surface of the base material. Specifically, once a desired depth has been achieved, the insert could be slowly lifted to a second more shallow depth in the substrate to allow a better flow of the plasticized material into any cavities in the insert and/or generally encompassing the engaging end of the insert. Rotation could then be stopped to allow the base material to solidify. Quenching may be done during or at the end of the process to promote high hardness or any other desired qualities of the base material and/or insert.

In one aspect, it may be desirable to enhance the shape or material strength of the wear-resistant insert. For example, a shape of the insert may be selected to reduce any concentrated stress that could exceed the material's cohesive strength. More specifically, the shape of the insert could also be produced in a way that would reduce the likelihood of the generation of stress risers, which may include, but is not limited to, the use of rounded edges (also termed rounded surfaces) and fillets to reduce such potential for stress concentration. The wear-resistant insert may be made of carbide, ceramic, metal or another material with similar properties that are capable of use in friction welding. The wear-resistant insert may also be coated with a coating material that may promote friction to improve heating of the base material. The coating material may provide an alloying agent to the base material to further ensure higher hardness and wear resistance. In other embodiments, the coating may provide corrosion resistance or any other desired function.

The shape of the insert and/or the coating material applied to the insert may provide enhanced mechanical fraction retention of the wear-resistant insert. The process may be done with manually controlled equipment or automated equipment. It is contemplated that friction welding can be achieved in many ways, which may include, but is not limited to, spinning, orbital, or linear friction stir welding.

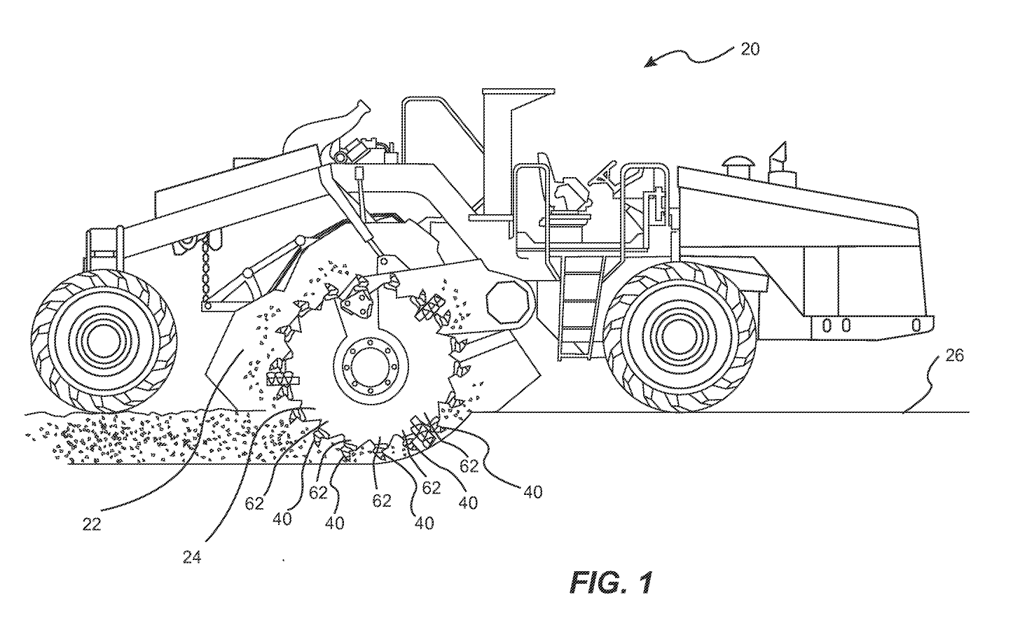

Referring to FIG. 1, a road asphalt reclaimer 20 is illustrated. FIG. 1 shows the asphalt reclaimer 20 with an exposed region 22 that has the cover or housing that typically would cover a rotor drum 24 removed to better illustrate the rotor drum 24. In particular, an example of a ground-engaging tool such as a rotor drum 24 may include multiple welded wear resistant inserts 40 on a rotor drum 24 used to pulverize asphalt 26. For example, an insert 40 may be a cutter bit. The wear-resistant insert 40 and the substrate 62 may interface and may be permanently joined by friction welding. The base substrate 62 may be pre-manufactured to be shaped to receive a specific insert 40 or may not be pre-manufactured to fit with the insert 40 and can be adjusted or adapted to receive any sized insert 40.

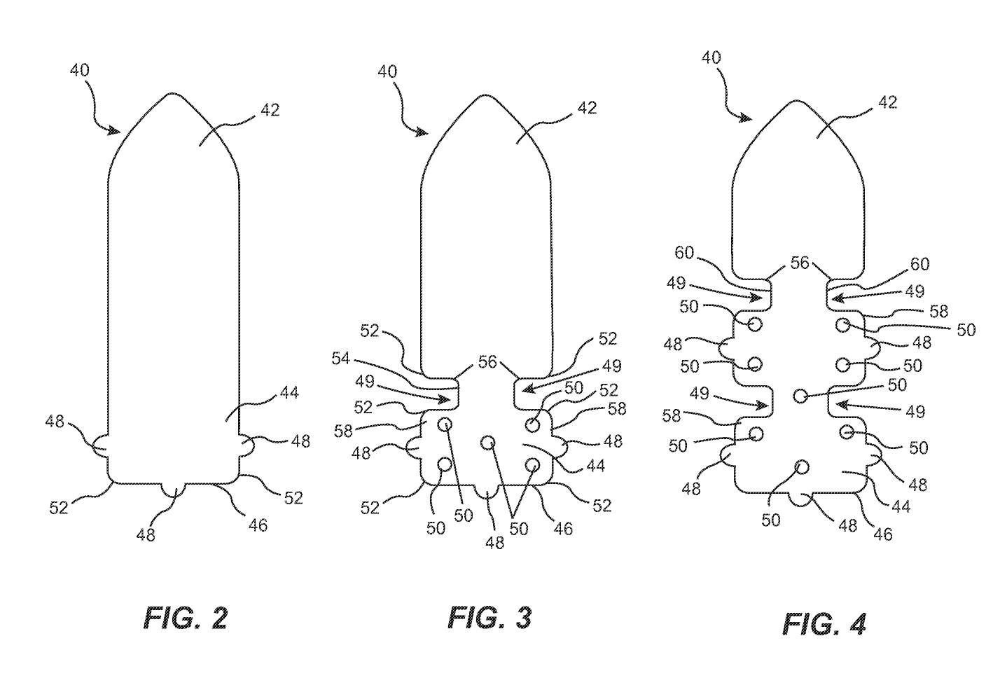

Referring now to FIGS. 2-5, in preferred embodiments a typically unaltered insert 40 is shown. The insert 40 in FIGS. 2-8 is shaped differently than the insert 40 of FIG. 1, as inserts 40 in accordance with the present disclosure may vary in shape. The insert 40 may be designed with enhancements. These enhancements can be achieved through configuring the shape and/or material strength of the wear-resistant insert 40 depending on the potential use and ultimately ensure a longer lifecycle of the insert 40. For example, an insert 40 might have rounded edges or a special coating to prevent any concentrated stress (not pictured and also referred to as a stress riser) that could cause material failure by exceeding the material's cohesive strength.

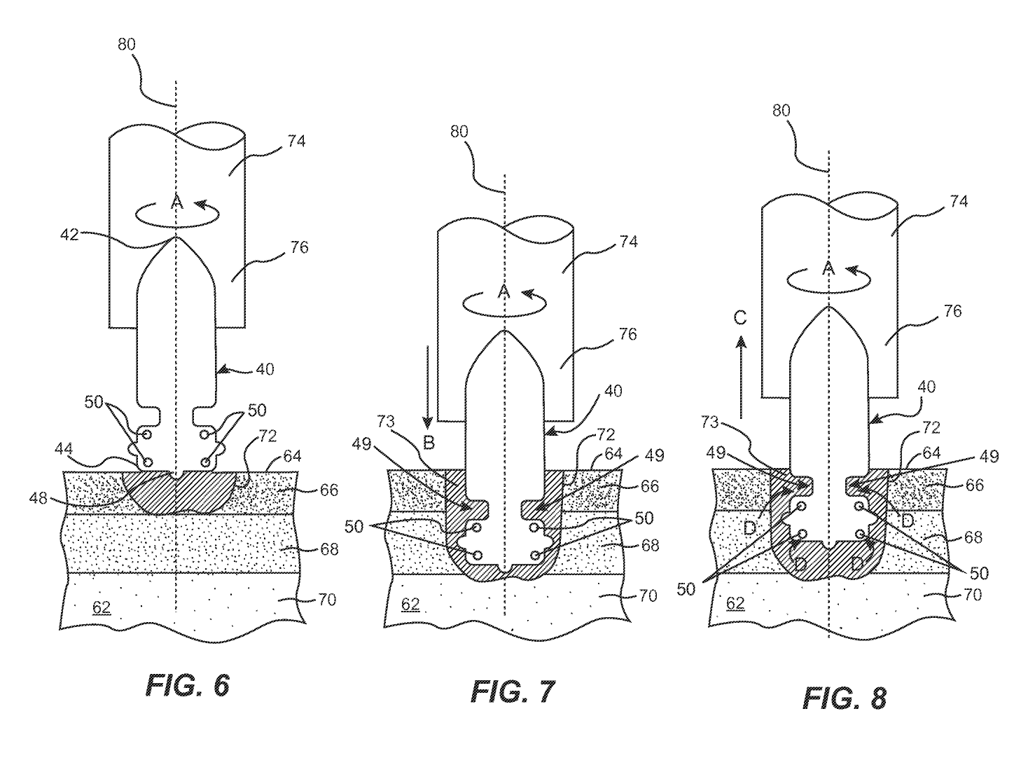

In one aspect shown in FIG. 2, an insert 40 may be elongated with engaging portions and free portions such as a free end 42 and an engaging end 44. The engaging end 44 includes an engaging end surface 46 that can interface with the substrate 62 and substrate surface 64, as further explained below with respect to FIGS. 6-8. In one aspect, the insert 40 may include at least one protrusion 48 near the engaging end 44 such that the protrusion 48 is centered to be able to localize and generate a sufficient amount of heat necessary for developing a heat-affected area on the substrate 62. In one aspect, a rounded edge 52 instead of a squared or sharp corner may cause an object to experience less likelihood of a local increase in the intensity of a stress field.

In one aspect shown in FIG. 3, an insert 40 may include at least one type of a retention cavity 49. Specifically, a retention cavity 49 can be also referred to as a pre-drilled or otherwise formed hole 50 on the engaging end 44 of the insert 40. The retention cavity 49 can also be referred to as a retention groove 54 to form a stepped or castellated portion 58 on the engaging end 44 of the insert 40. The groove 54 can encircle the insert 40 or run along the periphery of the insert 40. A retention cavity 49 can be located closer to an engaging end 44 than the free end 42 and where there is a junction between the retention cavity 49 on a side of the portion defining a rounded surface or rounded edge 52.

In an aspect seen in FIG. 4, an insert 40 may be configured to include a retention cavity 49 such as a second groove 60 near the engaging end 44. The second groove 60 is defined by a stepped or castellated portion 58, rounded edges 52 and fillets 56. The insert 40 may also include a plurality of holes 50 located in close proximity to the first groove 54 and second groove 60. The insert 40 may also include a plurality of protrusions 48 located at selected locations near the engaging end 44 of the insert 40.

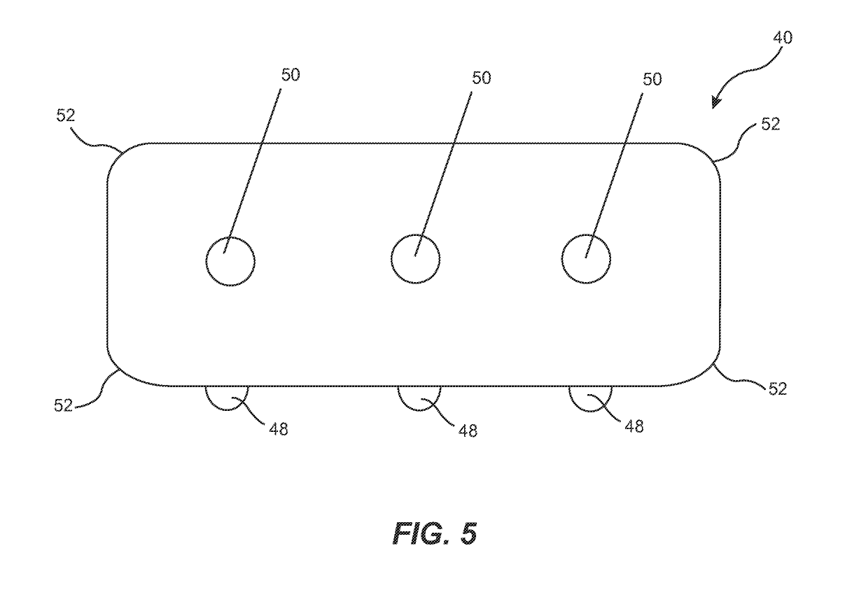

The physical shape of an insert 40 to be used in a friction welding process can be any shape, whether the shape be cylindrical (as illustrated in FIGS. 2-4), shaped like teeth or cutters (FIG. 1), spherical (not pictured), or can be a quadrilateral shaped tile, as shown in FIG. 5. For example, brazing or friction welding may be performed on a thin tile insert 40 and then brazed onto the front of a rotor blade. Further, a plurality of protrusions 48, holes 50 or rounded edges 52 may be included on the insert 40 as seen here in FIG. 5.

The friction-welding of an insert 40 will be described hereinafter with reference to FIGS. 6, 7 and 8. The friction-welding method and the related methods of operation may be controlled in response to one or more operational parameters such as material strength, force needed, pressure needed, time constraints, and other parameters.

FIG. 6 illustrates a welding tool 74 with an end effector 76 gripping an insert 40 on the free end 42 as it first begins to spin the insert 40 in a rotational direction illustrated by Arrow A around a centered axis 80 against the substrate 62. In alternate embodiments, the spinning may occur in a direction opposite of Arrow A. The tool 74 may be a mill or lathe, or any type of tool 74 that exerts a lot of force and can withstand the resistance of the workpieces being friction welded. The tool 74 might have an end effector 76 that is shaped to interface with and grip the insert 40. For example, an end effector 76 might be a chuck. The tool 74 may be manually controlled equipment or automated equipment. In an aspect, the substrate 62 can be homogeneous (not pictured) or have different layers like a first substrate layer 66, a second substrate layer 68, or even a third substrate layer 70 into which the insert 40 might be embedded. These layers can further help achieve a desired wear-resistant weld given one layer of a substrate 62 layer might have different melting properties and densities than another substrate layer, yet in combination the two or more layers act in harmony to create the desired tough and resilient weld.

In one embodiment, an engaging end 44 of the insert 40 interfaces with the substrate surface 64, and the engaging end 44 may include a protrusion 48 purposefully centered along the axis 80. This protrusion 48 helps to centralize the heat to create a heat-affected zone 72 in the substrate 62 as the tool 74 moves the insert 40. The heat-affected zone 72 may soon become a plasticized state that is capable of plastically displace and fusing the insert 40 with the substrate 62.

FIG. 7 illustrates the continued operational mode of the welding tool 74 pressing the insert 40 to a first depth in the substrate 62 as the heat-affected zone 72 remains in a plasticized state. As the tool 74 continues to spin, the tool 74 presses the insert 40 in the direction illustrated by Arrow B into the substrate 62. The heat-affected zone 72 will enlarge in the substrate 62 and can enlarge into a first substrate layer 66, second substrate layer 68, or third substrate layer 70. The insert 40 may be embedded into any type of homogenous or multi-layered substrate 62. A first depth of how far to press the insert 40 into the substrate initially might be pre-determined depending on the desired use of the insert 40. If there are retention cavities 49, then the insert 40 is pressed to a first depth into the substrate 62 so as to allow the retention cavities 49 to surpass the plane of the substrate surface 64.

FIG. 8 illustrates the continued operational mode of the welding tool 74 bringing the insert 40 to a second depth of a substrate 62. In the disclosed embodiment, after the insert 40 is moved to a first desired depth within the substrate 62, the welding tool 74 moves the insert 40 in the direction of Arrow C to a second depth which is more shallow within the substrate 62 than the first depth. This second depth may be achieved while simultaneously or after slowing the rotation of the tool 74 but the slowing is optional. This type of “pull-back” motion of the tool 74 may enhance the flow of plasticized material 73 from the heat-affected zone 72 into any number of retention cavities 49 that exist on or around the insert 40 as illustrated by Arrow D. Thus the “weld” is further strengthened and reinforced by the substrate 62 when the substrate 62 acts to permanently “grip” or “encapsulate” the insert 40 upon future cooling.

In one aspect, the combined inclusion of one or more of rounded edges 52 and fillets 56 aid in minimalizing localized stress concentrations on a sharp-edged or cracked insert 40. Once the insert 40 achieves its fixed position, then the tool 74 movement is finally stopped so as to allow the wear resistant insert 40 and the base component substrate 62 to solidify into one resultant workpiece. During the cooling and hardening period, the grooves 54,60 stepped or castellated portions 58, and holes 50 provide places for plasticized material 73 to flow into the insert 40 to provide a better bond between the insert 40 and substrate 62.

Three examples of friction welding operational modes that can be used to embed a wear resistant insert 40 into the desired component substrate 62 are illustrated in FIGS. 6-8 and FIGS. 9-10.

Referencing back to FIGS. 6-8, a first operational friction welding mode known as spin-welding is illustrated. Spin-welding involves spinning an insert 40 at a high rate of rotation shown by Arrow A. Further, the welding tool 74 is gripping and spinning the insert 40 around a center axis 80 of the insert 40 against fixed base substrate 62 to create heat via friction between the insert 40 and the substrate 62.

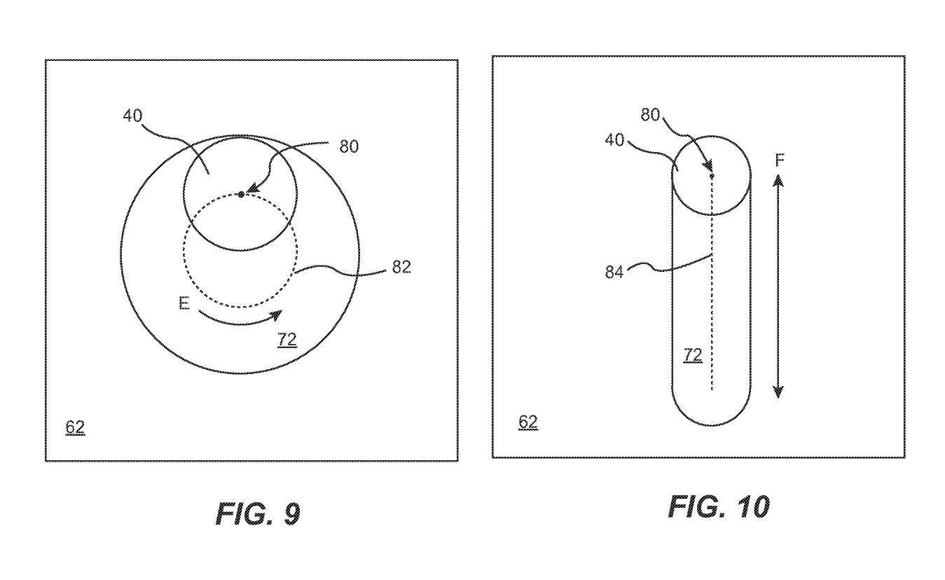

Referencing FIG. 9, a second operational friction welding mode known as orbital friction welding is shown. Orbital friction welding is similar to spin—or rotary—friction welding where the insert 40 and the substrate 62 are rotated relative to each other but with their respective axes 80 offset. In some embodiments, the axis 80 may be offset by up to 3 mm. The path the insert 40 follows runs in a type of small orbital friction path 82 in a direction indicated by Arrow E.

Referencing FIG. 10, a third operational friction welding mode known as linear friction can be used to embed a wear resistant insert 40 into the substrate 62. Linear friction welding is similar to spin welding except that the welding tool 74 oscillates laterally along a linear friction path 84 as indicated by Arrow F instead of, or in addition to, spinning The speeds may be much lower in general, which may result in the pieces to be kept under pressure at all times. Linear friction welding may be use more complex machinery than spin welding, but has the advantage that parts of any shape can be joined. Another advantage is that in some instances quality of joint is better than that obtained using rotating technique.

### INDUSTRIAL APPLICABILITY

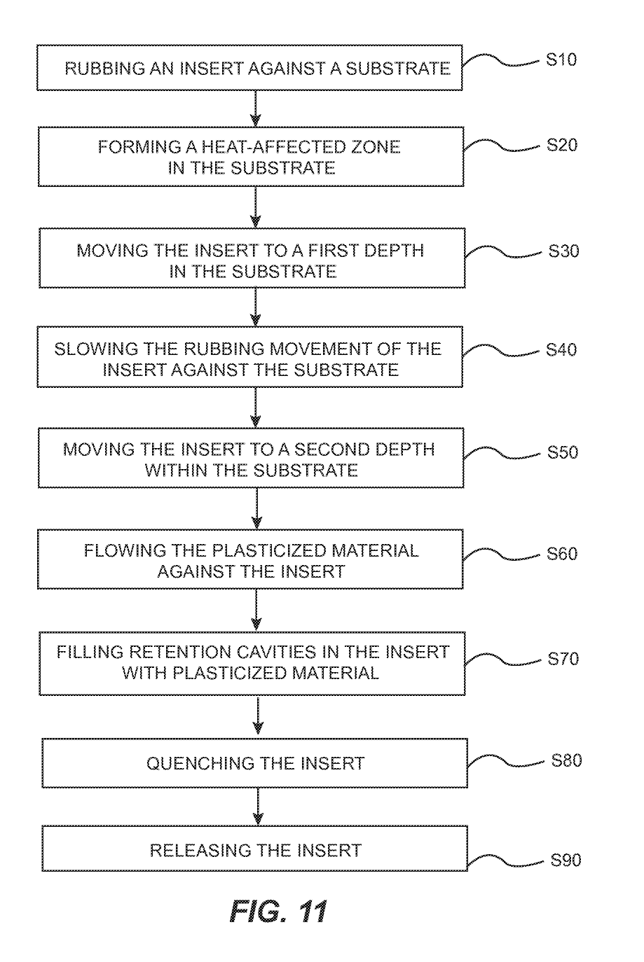

The present disclosure is applicable to any type of friction welding that is contemplated being used with a wear-resistant insert 40. The operational mode of the friction welding process described below with reference to FIG. 11 as well as FIGS. 2-8 may cater to the various operational requirements of the machinery or ground-engaging tools. This can include adjustment for varying forces and pressures required to friction weld.

FIG. 11 is a flowchart of the method and process for attaching an insert 40 into a substrate 62. In Step S10, a welding tool 74 begins to rub an insert 40 against a substrate 62, which over a period of time, as shown in Step S20, this rubbing forms a heat-affected zone 72 in the substrate 62. In Step S30, as the tool 74 continues to spin, the tool 74 presses the insert 40 in a direction shown by Arrow B into the substrate 62. The first depth of how far to press the insert 40 into the substrate 62 may be pre-determined depending on the perceived industrial use of the wear-resistant insert 40. Step S40 is an optional step where at any point the tool 74 can be slowed rotationally as the continued rubbing movement of the insert 40 against the substrate 62 persists. In Step S50, then the tool 74 moves and extends the insert to a second depth within the substrate 62. The second depth is more shallow than the first depth. This leads directly to Step S60, where the plasticized material 73 flows against the insert 40. In Step S70, this type of “pull-back” motion of the tool 74 set forth in Step S50 is designed to enhance the flow of plasticized material 73 from the heat-affected zone 72 into any number of retention cavities 49. During the cooling and hardening period, the grooves 54,60 stepped or castellated portions 58, or holes 50 provide places for plasticized material 73 to flow into the insert 40 to provide a better bond between the insert 40 and substrate 62. In Step S80, the friction welding process also may involve quenching the insert 40. Quenching can use any common quenching technique to promote high hardness of the base material substrate 62 and/or insert 40. The quenching Step S80 may include a quench material like water or oil. In Step S90, the tool 74 releases the insert 40 from the end effector 76.

The method may further involve the step of coating the insert 40, or more properly referred to as friction surfacing. Friction surfacing is a process where a coating material is applied, such as a friction-enhancing or alloy-promoting material, before the tool 74 begins to spin the insert 40 into the substrate 62. A rod composed of the coating material is rotated under pressure, generating a plasticized layer in the rod at the interface of the engaging end surface 46 of the insert 40 with the substrate 62. By moving a substrate 62 across the face of the rotating rod a plasticized layer is deposited between 0.2-2.5 mm thick depending on rod diameter and coating material. When coating or friction surfacing a piece, the structure might change because the temper in the steel is lost. In friction stir welding, loss of temper is minimal, and performing the coating quickly minimizes the tempering effect. However, it may be desired to coat the material to restore some of the hardness present in the material prior to the steel losing its temper. The coating material might be chrome, carbon, silicon or a material with similar properties. As such, the coating could involve multiple compositions.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

We claim:

1. An insert, comprising:
a body, having an engaging portion and a free portion located opposite the engaging portion;
a side portion of the body defining a retention cavity, the retention cavity being located closer to the engaging portion than the free portion;
a junction between the retention cavity on a side of the portion defining a rounded surface; and
a protrusion extending from a surface on the engaging portion.

2. The insert of claim 1, further comprising a second retention cavity located near the engaging portion.

3. The insert of claim 1, further comprising a hole located in at least one of either the side portion and the engaging portion.

4. The insert of claim 1, further comprising a second protrusion extending from a surface on the engaging portion.

5. The insert of claim 1, further comprising a fillet defined by a junction between a side portion of the body and a retention groove.

6. The insert of claim 1, further comprising a coating on the body.

7. The insert of claim 1, wherein the body consists of at least one of the following: carbide, ceramic, and metal.

8. The insert of claim 1, further comprising a substrate encompassing the engaging portion of the body.

9. The insert of claim 8, wherein the substrate further comprises multiple substrate portions.

10. A ground engaging element for a machine, the ground engaging element comprising:
a substrate; and
an insert having a body, which has an engaging portion and a free portion located opposite the engaging portion; a side portion of the body defining a retention cavity, the retention cavity being located closer to the engaging portion than the free portion; a junction between the retention cavity on a side of the portion defining a rounded surface; and a protrusion extending from a surface on the engaging portion,
wherein the insert is embedded into the substrate and the substrate material is located in the retention cavity.

11. The ground engaging element of claim 10, wherein the substrate includes multiple substrate portions and the insert extends through at least two layers of the substrate.

12. The ground engaging element of claim 10, wherein a portion of the substrate is located in a retention groove.

13. A method for attaching an insert to a substrate, comprising:
rubbing the insert against the substrate;
forming a heat-affected zone in the substrate;
forming plasticized substrate material from friction resulting from the rubbing;
moving the insert to a first depth in the heat-affected zone in the substrate;
moving the insert to a second depth in the heat-affected zone in the substrate, wherein the first depth is deeper than the second depth;
flowing the plasticized material against the insert; and
releasing the insert.

14. The method of claim 13, further comprising slowing the rubbing of the insert against the substrate after the step of moving the insert to a first depth in the substrate.

15. The method of claim 14, further comprising filling a retention cavity in the insert with the plasticized substrate material.

16. The method of claim 13, further comprising quenching the insert.

17. The method of claim 13, wherein the rubbing is done by spinning the insert.

18. The method of claim 13, wherein the rubbing is done by moving the insert along a linear path.

19. The method of claim 13, wherein the rubbing is done by moving the insert along an orbital path.

20. The method of claim 13, further comprising coating the insert.
